(19) United States
(12) Patent Application Publication
(10) Pub. No.: US 2005/0274654 A1
(43) Pub. Date: Dec. 15, 2005

(54) Method and apparatus for sifting soil

(76) Inventors: Louis George Sukovaty, Winthrop, WA (US); Jennifer Lynn Argraves, Winthrop, WA (US)

Correspondence Address: SEED INTELLECTUAL PROPERTY LAW GROUP PLLC, 701 FIFTH AVE, SUITE 6300, SEATTLE, WA, 98104-7092, US

(21) Appl. No.: 11/107,376

(22) Filed: Apr. 15, 2005

Related U.S. Application Data
(60) Provisional application No. 60/562,305, filed on Apr. 15, 2004.

(51) Int. Cl. B07B 1/28; B07B 1/42

(52) U.S. Cl. 209/365.2

(57) ABSTRACT

A sifter comprising a frame, a screen carriage moveably coupled to the frame and an oscillation drive assembly. In one embodiment, the oscillation drive assembly comprises a cam with a two-force member coupled to an offset mount on the cam.

### TECHNICAL FIELD

The present invention is directed to a device for sifting and distributing soil, and more particularly, to a portable, motorized soil sifter and related method of sifting soil, sand, aggregate, and similar materials that is inexpensive, highly flexible and readily useable by home gardeners.

### BACKGROUND OF THE INVENTION

Home gardeners have many options available to them for tilling, but not much is available for the difficult task of sifting the soil after it has been tilled to remove rocks, vegetation clumps and other debris, and to break up clumps in the soil.

Traditional soil sifters are large and expensive and directed more toward large-scale agricultural or construction uses. For example, the screening device disclosed in U.S. Pat. No. 6,742,658 must be mounted to a dump truck, which renders it unsuitable for home gardening applications.

### BRIEF SUMMARY OF THE INVENTION

In one aspect, a portable soil sifter is provided that may be powered or hand operated and may be self-propelled, partially self-propelled or manually propelled. Separate controls may be provided for propulsion and for sifting operations. The filtering elements or screens may be readily removable. In one embodiment, the sifter is approximately the size of a wheel barrel.

In one aspect, a sifter is provided that includes a frame, a screen carriage moveably mounted to the frame, a screen assembly securable in the screen carriage, and an oscillation drive assembly mounted on the frame and coupled to the screen carriage and configured to drive an oscillating movement of the screen carriage.

In one embodiment, the oscillating drive assembly includes an electric motor, a drive shaft mechanically coupled to the electric motor, a cam mounted on the drive shaft, and a two-force member coupled to the cam and to the screen carriage. In one embodiment, the electric motor is controlled by a switch. In one embodiment, a generator is mounted on the frame and electrically coupled to the electric motor.

In one embodiment, a battery is mounted on the frame and coupled to the oscillation drive assembly. Ideally, the oscillation drive assembly includes a system of pulleys and belts, and the oscillation drive assembly is configured to drive oscillation of the screen carriage with an oscillation period in the range of 50-400 oscillations per minute and preferably of at least one-hundred oscillations per minute.

In one embodiment, the oscillation drive assembly includes an engine, a drive shaft mechanically coupled to the engine, a cam mounted on the drive shaft, and a two-force member coupled to the cam and to the screen carriage. Preferably, the engine is coupled to the drive shaft through a system of pulleys and belts, and the engine is mechanically coupled to the drive shaft through a clutch controlled by a mechanical lever.

In accordance with another aspect of the present invention, the screen assembly has a plurality of removable screens, and the frame is approximately two-feet wide and four feet long.

In accordance with another aspect, a sifter is provided that includes a frame, a device for sifting, a device for mounting the sifting device to the frame, and a device for oscillating the mounting device and sifting device with respect to the frame. In one embodiment, the oscillating device is powered by an electric motor. In another embodiment, the oscillating device is powered by an engine. Ideally, the oscillating device includes a cam with an offset mount coupled to a two-force member.

### BRIEF DESCRIPTION OF THE SEVERAL VIEWS OF THE DRAWINGS

The foregoing features and advantages will be more appreciated as the same become better understood from the following detailed description when taken in conjunction with the accompanying drawings, wherein:

FIG. 1 is an isometric illustration of one embodiment of a sifter formed in accordance with the present invention;

FIG. 2 is a rear view of the embodiment of the sifter of FIG. 1;

FIG. 3 is a rear view of the embodiment of the sifter of FIG. 1 with the screen removed;

FIG. 4 is an isometric view from the front of the embodiment of the sifter of FIG. 1;

FIG. 5 is a top-angle view of an embodiment of a screen assembly suitable for use with the embodiment of FIG. 1;

FIGS. 6 and 7 are detailed isometric views of an oscillating drive assembly suitable for use with the embodiment of FIG. 1;

FIG. 8 is top plan view of an embodiment of a screen carriage assembly;

FIG. 9 is side view of screen carriage components;

FIG. 10 is a cross-sectional view of a pivot assembly taken along line A-A of FIG. 9;

FIG. 11 is a side view of an electric screen oscillator drive assembly of one embodiment;

FIG. 12 is a cross-sectional view of a cam assembly taken alone line A-A of FIG. 11; and

FIG. 13 is a side view of an engine screen oscillator drive assembly of one embodiment.

### DETAILED DESCRIPTION OF THE INVENTION

The present disclosure provides for a soil sifter that is strong, versatile and moderate in cost and related method of sifting soil and other similar material. The soil sifter will be described using a limited number of example embodiments and drawings.

The drawings are not necessarily drawn to scale. The shapes and sizes of components are selected for ease of illustration and understanding. Similar reference numbers in the drawings represent similar elements and structures, unless the context indicates otherwise.

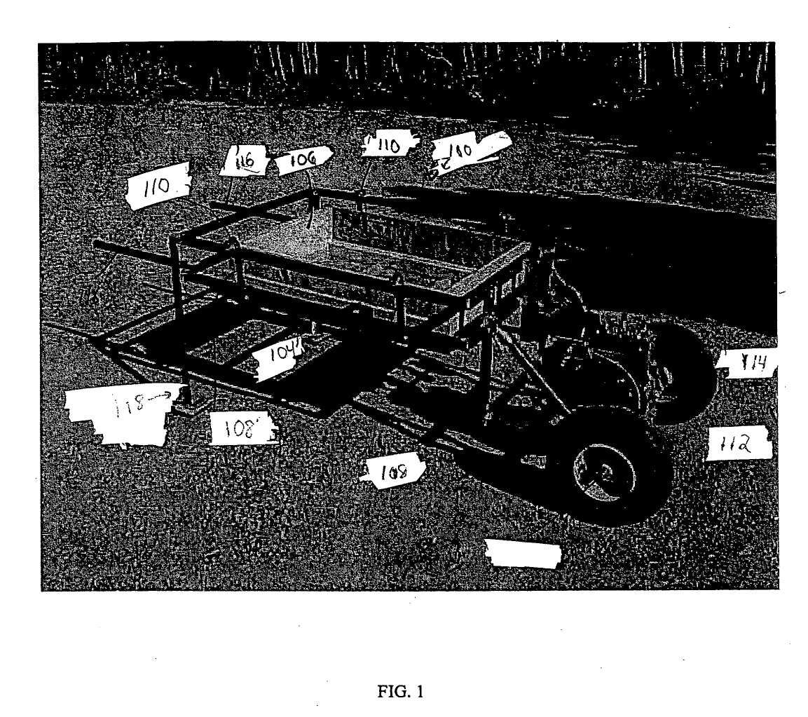

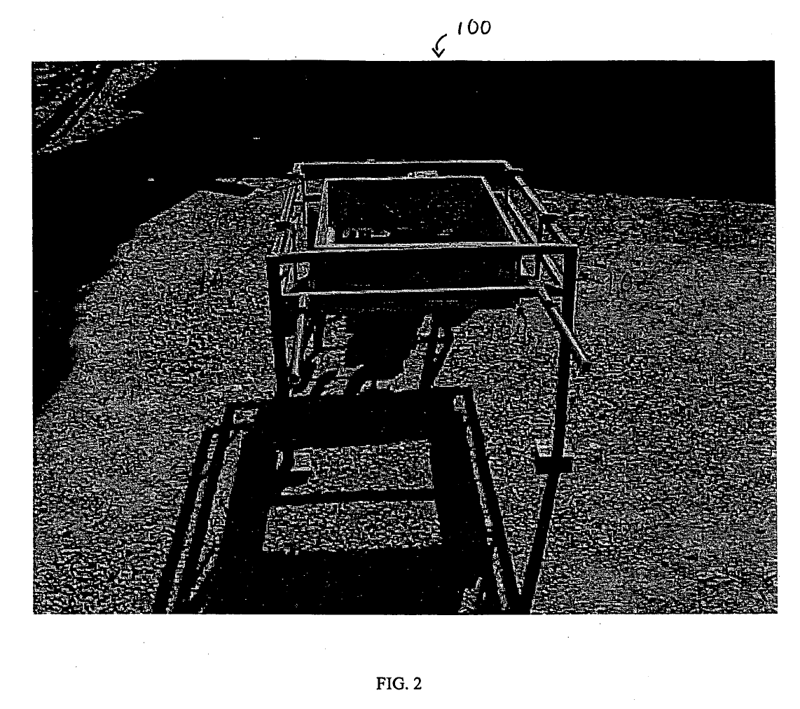

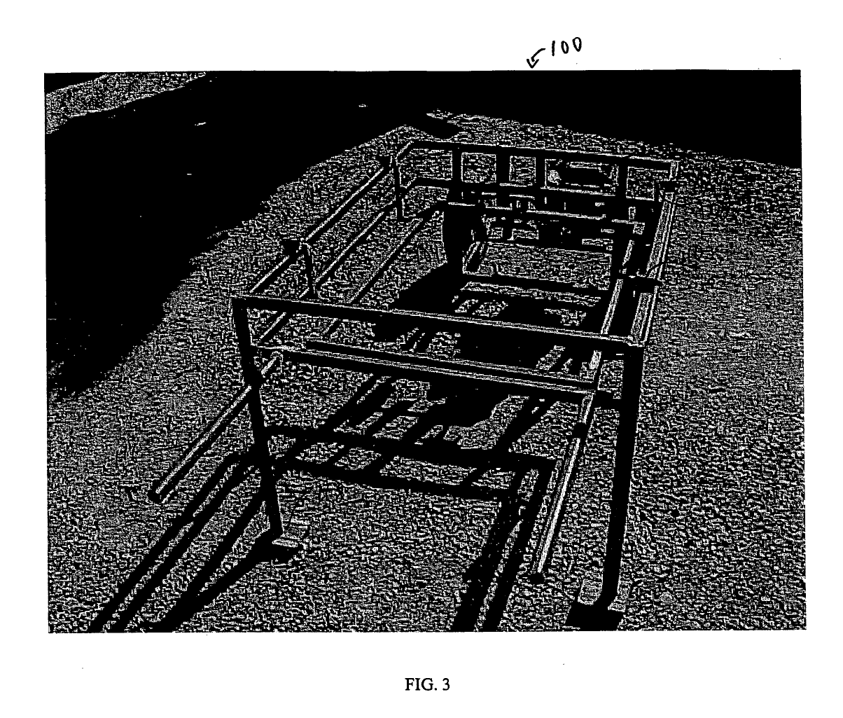

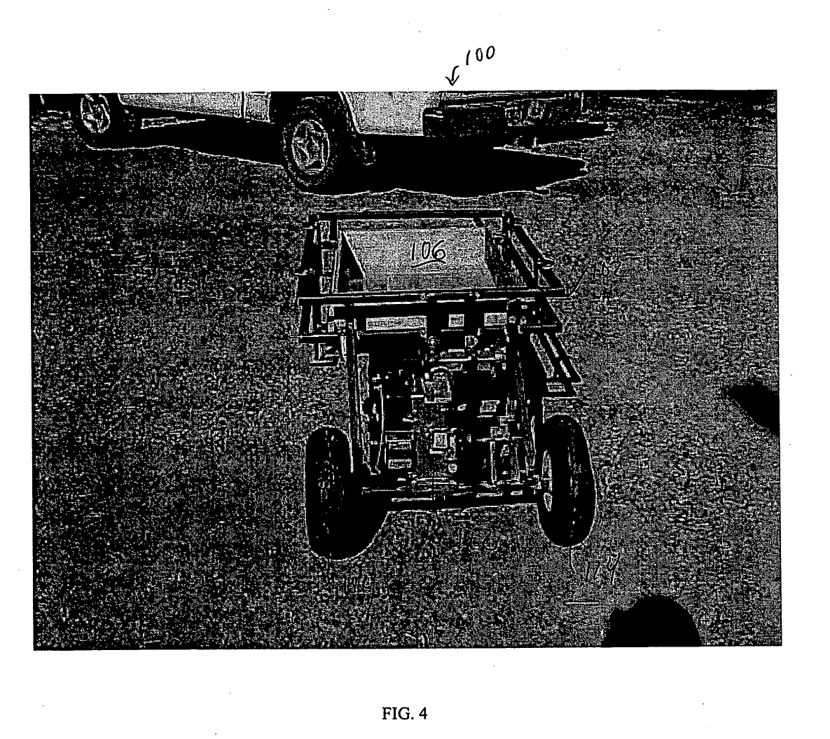

FIGS. 1 through 4 illustrate a soil sifter 100 that includes a frame 102 having a screen carriage 104. The screen carriage 104 is movably coupled to the frame 102 and supports a removable screen assembly 106. In FIG. 3, the screen assembly 106 is removed to provide a better view of the screen carriage 104. The screen carriage 104 is attached to the frame 102 by pivot arms 108 that engage pivot arm mounts 110 on the frame 102. The pivot arms 108 are described in more detail below in the description of FIG. 10. In the illustrated embodiment, the screen carriage 104 is a pendulum-hung frame. In other embodiments, a ball and socket or rubber mount mechanism may be employed.

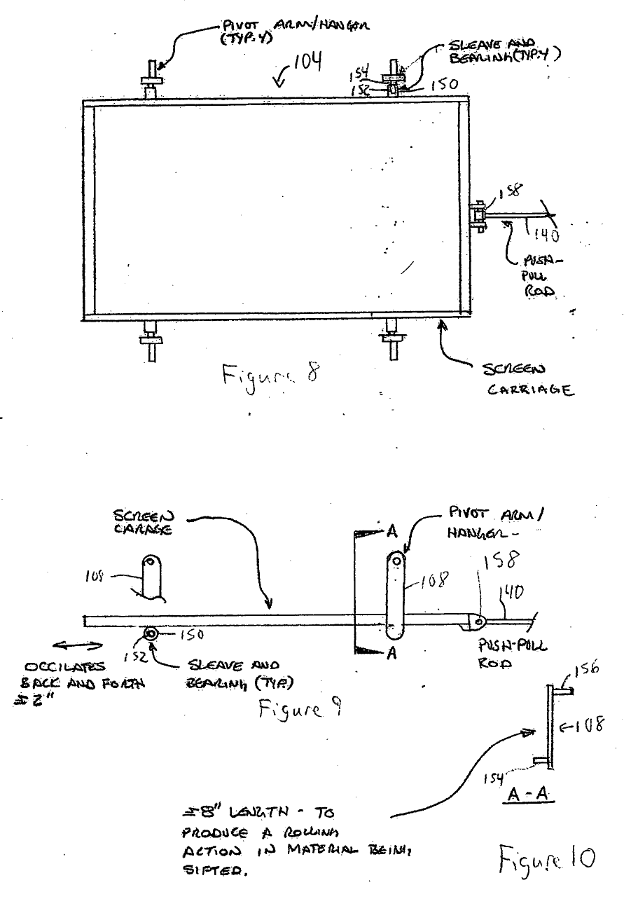

Referring now to FIGS. 1 through 4, the soil sifter includes a motor or engine 112 mounted on the frame 102. The motor or engine 112 provides power for driving movement of the screen carriage 104, as discussed in more detail below. In some embodiments, an electric motor is employed as the driving force (see FIG. 11). In some embodiments, a gas-powered engine is employed (see FIG. 13). In some embodiments, a hand turned crank (not shown) may be employed in place of the motor or engine 112.

The frame 102 has wheels 114 and handles 116 mounted on it to facilitate moving the soil sifter 100. The frame 102 also includes feet 118 for supporting the soil sifter 100. In some embodiments, the feet 118 may be replaced with additional wheels.

In some embodiments, the wheels 114 may be coupled to the motor or engine 112, or to a second motor or engine (not shown), by a drive mechanism (not shown) for assisted or self-propulsion of the soil shifter 100. In some embodiments, separate controls (not shown) may be provided for engaging driving movement of the screen carriage 104 and an optional drive mechanism for assisted or self-propulsion of the soil sifter 100.

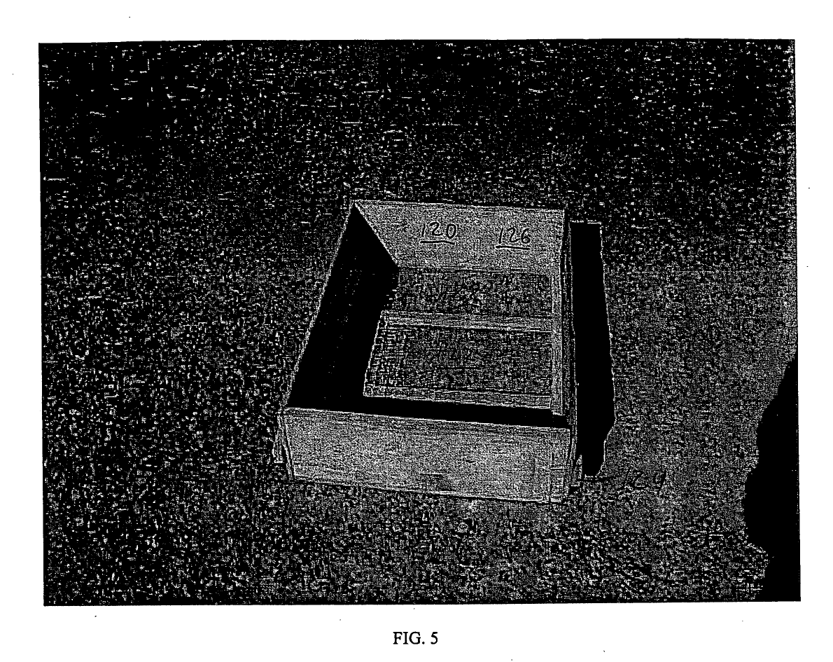

FIG. 5 illustrates a screen assembly 106 suitable for use with the embodiment of a soil sifter 100 illustrated in FIGS. 1 through 4. The screen assembly 106 has a screen frame 120 and one or more screens 122 secured to the screen frame 120. The screen assembly 106 has support rails 124 that engage the screen carriage 104 so as to hold the screen assembly 106 securely in the screen carriage 104.

Ideally, the screens 122 can be easily removed from the screen frame 120 and replaced with screens having different size holes. The walls 126 of the screen frame 120 can have different heights to provide for different capacity screen assemblies 106. The screen assembly 106 can be easily removed from the soil sifter 100 to facilitate emptying of the screen assembly 106 when it becomes full of debris, or refilling of the screen assembly with new material for distribution, without requiring the entire soil sifter 100 to be moved to another location for emptying. Optional handles (not shown) can be attached to the walls 126 of the screen assembly 106 to facilitate carrying a full screen assembly 106. Different size screens can be employed to direct material of different sizes out of the sifter 100 at different locations. For example, smaller materials could be directed downward while larger materials were directed to one side.

In some embodiments, screens in different vertical planes may be employed, or screens 122 may be employed in the walls 126 of the screen frame 120. Although the illustrated screens are rectangular, other screen shapes may be employed. For example, round or square screens may be employed. The illustrated screen frame 120 is made of wood, but other materials and combinations of materials, such as plastic or metal, may be employed.

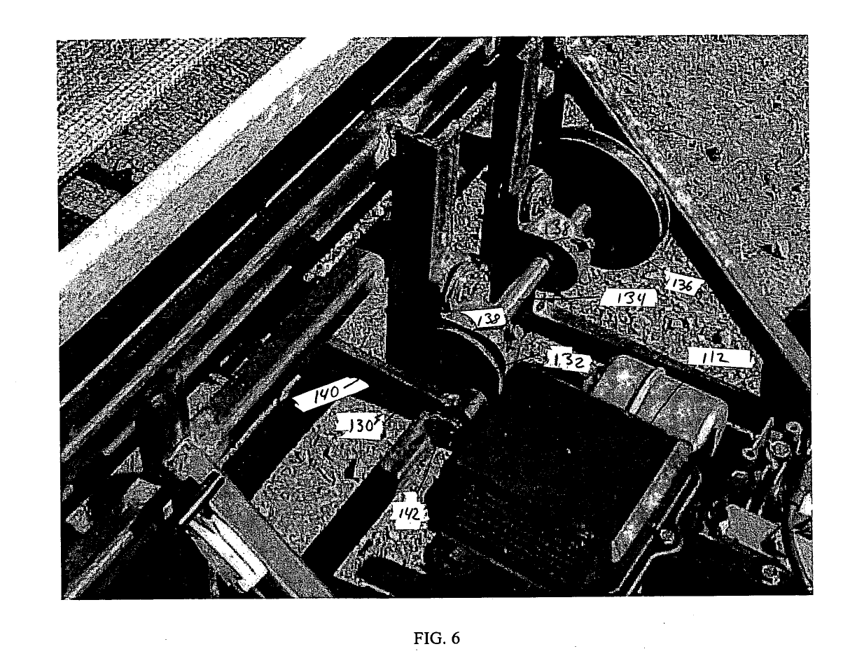

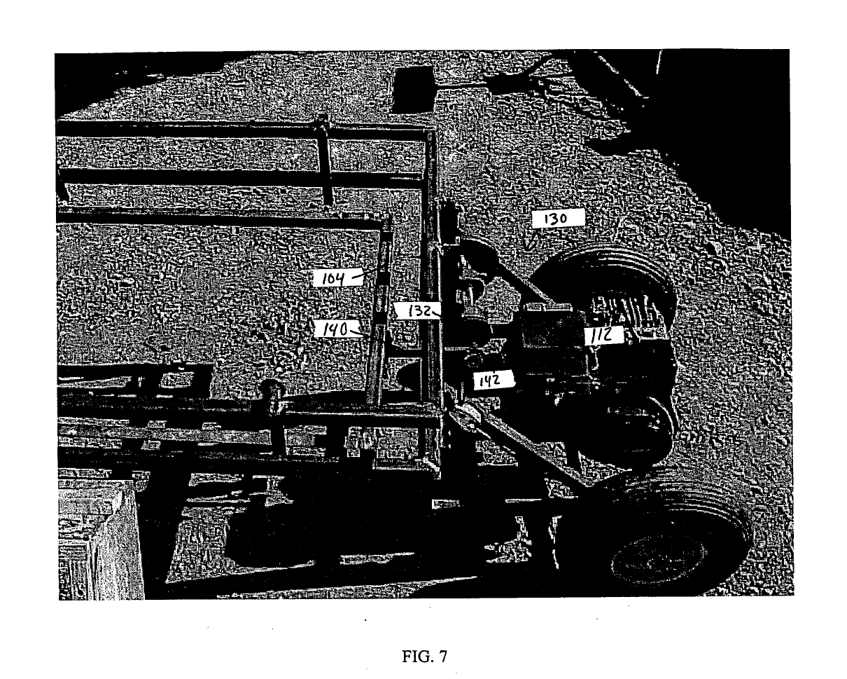

FIGS. 6 and 7 illustrate an oscillating drive assembly 130 suitable for use with the embodiment of FIG. 1. A cam 132 is mounted on a shaft 134. A pulley 136 also is mounted to the shaft 134. The shaft 134 is mounted to the frame 102 by bearings 138. The pulley 136 is connected by a belt to a drive mechanism, which may be driven by the motor or engine 112 (See FIGS. 11 and 13). The screen carriage 104 has a two-force member or push-pull rod 140 that is off-set mounted to the cam 132 at off-set mount 142. As the cam 132 rotates, vertical and horizontal forces are applied to the two-force member or push-pull rod 140, resulting in horizontal and vertical oscillation of the screen carriage 104 and thus of the screen assembly 106. Other oscillating drive assemblies may be employed, for example, gear movements may be employed. The movement of the screen assembly that is generated can be linear or rotational in one or more planes, or can be combinations of linear and rotational movement in one or more planes. If necessary or desirable, counterweights (not shown) can be permanently or temporarily mounted to the frame 102 to reduce movement of the frame 102 in response to forces introduced by the oscillating drive assembly 130.

FIGS. 8 through 10 illustrate in more detail the screen carriage 104 and the pivot arms 108 of the embodiment of FIG. 1. The screen carriage 104 includes sleeves 150 with bearings 152 for receiving lower pins 154 on the pivot arms 108. The pivot arms 108 have upper pins 156 for engaging the pivot arm mounts 110 (see FIGS. 1 through 4). The push-pull rod or two-force member 140 is mounted at a pivot point 158 to the screen carriage 104. The arrangement of the push-pull rod 140, lower and upper pins 154, 156 and sleeves 150 with bearings 152 permit oscillating movements of the screen carriage 104 with respect to the frame 102.

FIG. 11 illustrates an oscillating drive assembly 130 coupled to an electric motor 112 and suitable for use in the embodiment of FIG. 1. The electric motor 112 is coupled via a pulley 160 and a belt 162 to a drive pulley 136. The motor 112 is activated by an electrical switch 164 that completes a circuit to supply power to the motor 112 from a power supply 166. In the illustrated embodiment, the power supply is a DC supply. Other power supplies could be employed, such as an AC generator (not shown) mounted on the frame 102, or an extension cord for connection to a line current. In the illustrated embodiment, the pulleys and cam 132 are sized so that operation of the motor 112 results in one-hundred and fifty to three-hundred two inch oscillations of the screen assembly 106 per minute. Other pulley and cam ratios may be employed to obtain oscillations with desired oscillation periods and movement ranges.

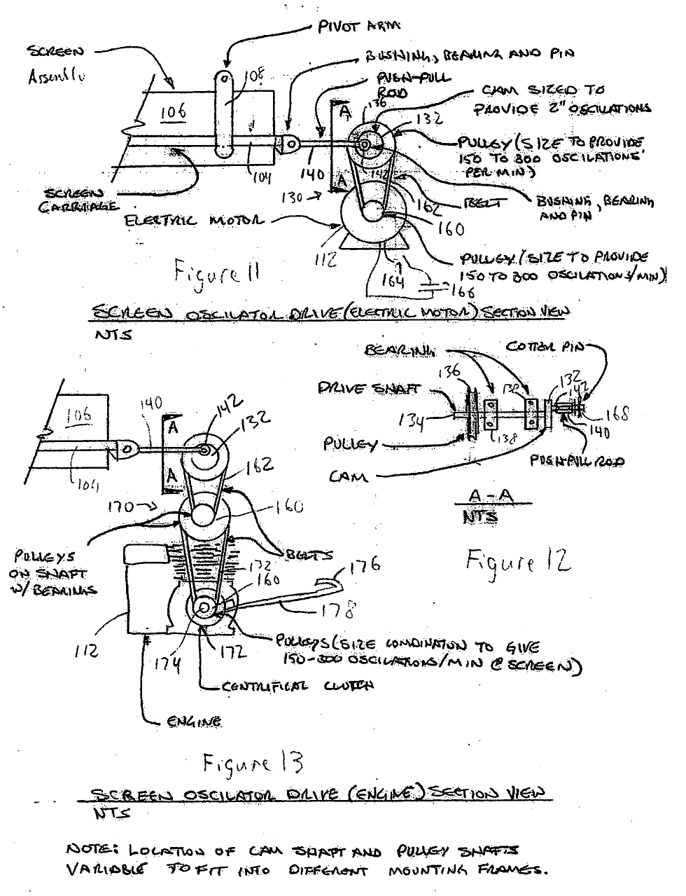

FIG. 12 illustrates in more detail the connection of the two-force member or push-pull rod 140 to the off-set mount 142 of the cam 132 of the embodiment illustrated in FIG. 11. The shaft 134 is mounted to the frame 102 in bearing mounts 138. The pulley 136 and the cam 132 are mounted to the shaft 134. The push-pull rod 140 is mounted on the off-set mount 142 and is held in place by a cotter pin 168.

FIG. 13 illustrates an oscillating drive assembly 130 coupled to an engine 112 and suitable for use in the embodiment of FIG. 1. The engine 112 is coupled via a system 170 of pulleys 160 and belts 162 to a drive pulley 136. The engine 112 has a clutch 172 for controlling rotation of a shaft 174. The clutch 172 is controlled by a mechanical lever 176 coupled to the clutch by a cable 178. The mechanical lever 176 may be mounted in a convenient location, such as on one of the handles 116 of the frame 102. In the illustrated embodiment, the system 170 of pulleys 160 and belts 162 and the cam 132 are sized so that operation of the engine 112 results in one-hundred and fifty to three-hundred oscillations of the screen assembly 106 per minute. Various systems 170 of pulleys 160 and belts 162 and cam ratios may be employed to obtain oscillations with desired oscillation periods and movement ranges and to accommodate various mounting frame and motor arrangements.

In operation, the sifter 100 receives material to be sorted into the screen assembly 106. The material may be either manually or mechanically loaded. For example, the output of another screener/sifter could be directed into the screen assembly 106, or a conveyer belt could be used to load material into the sifter 100. Although the examples discussed above referred to soil, other materials may be sifted or sorted using the sifter. For example, gravel, ore, grass seed, or rice could be sorted. Weight and/or size can be used as a sorting criteria.

From the foregoing it will be appreciated that, although specific embodiments of the invention have been described herein for purposes of illustration, various modifications may be made without deviating from the spirit and scope of the invention. Accordingly, the invention is not limited except as by the appended claims and the equivalents thereof.

1. A sifter, comprising:
a frame;
a screen carriage mounted on the frame;
a screen assembly securable in the screen carriage; and
an oscillation drive assembly mounted on the frame and coupled to the screen carriage and configured to drive the screen carriage in oscillating movement.

2. The sifter of claim 1 wherein the oscillating drive assembly comprises:
an electric motor;
a drive shaft mechanically coupled to the electric motor;
a cam mounted on the drive shaft; and
a two-force member coupled to the cam and to the screen carriage.

3. The sifter of claim 2 wherein the electric motor is controlled by a switch.

4. The sifter of claim 2 further comprising a generator mounted on the frame and electrically coupled to the electric motor.

5. The sifter of claim 1 further comprising a battery mounted on the frame and coupled to the oscillation drive assembly.

6. The sifter of claim 1 wherein the oscillation drive assembly comprises a system of pulleys and belts.

7. The sifter of claim 1 wherein the oscillation drive assembly is configured to drive oscillation of the screen carriage with an oscillation period of at least one-hundred oscillations per minute.

8. The sifter of claim 1 wherein the oscillation drive assembly comprises:
an engine;
a drive shaft mechanically coupled to the engine;
a cam mounted on the drive shaft; and
a two force member coupled to the cam and to the screen carriage.

9. The sifter of claim 8 wherein the engine is coupled to the drive shaft through a system of pulleys and belts.

10. The sifter of claim 8 wherein the engine is mechanically coupled to the drive shaft through a clutch controlled by a mechanical lever.

11. The sifter of claim 1 wherein the screen assembly comprises a plurality of removable screens.

12. The sifter of claim 1 wherein the frame is approximately two-feet wide and three four feet long.

13. A sifter comprising:
a frame;
means for sifting;
means for mounting the sifting means to the frame; and
means for oscillating the mounting means with respect to the frame.

14. The sifter of claim 13 wherein the oscillating means comprises an electric motor.

15. The sifter of claim 13 wherein the oscillating means comprises an engine.

16. The sifter of claim 13 wherein the oscillating means comprises a cam with an offset mount coupled to a two-force member.
